(19) United States
(12) Patent Application Publication
(10) Pub. No.: US 2024/0119094 A1
(43) Pub. Date: Apr. 11, 2024

(54) DATA CLASSIFICATION DEVICE, DATA CLASSIFICATION METHOD, AND PROGRAM RECORDING MEDIUM

(71) Applicant: NEC Corporation, Minato-ku, Tokyo (JP)

(72) Inventors: Banri ODA, Tokyo (JP); Kenichi Yasuda, Tokyo (JP); Yutong Zhang, Tokyo (JP)

(73) Assignee: NEC Corporation, Minato-ku, Tokyo (JP)

(21) Appl. No.: 18/273,422

(22) PCT Filed: Dec. 3, 2021
(86) PCT No.: PCT/JP2021/044406

§ 371 Date: Jul. 20, 2023

(30) Foreign Application Priority Data
Jan. 28, 2021 (JP) 2021-011603

(51) Int. Cl. G06F 16/906; G06F 16/904

(52) U.S. Cl. CPC G06F 16/906; G06F 16/904

(57) ABSTRACT

This data classification device comprises an acquisition unit, a data classification unit, an output unit, and an input unit. The acquisition unit acquires data to be classified as input data. The data classification unit uses a classification model to estimate the classification of the input data. The output unit outputs display data displaying: an image divided into a plurality of groups based on a group division standard based on the confidence level when the classification model estimates the classification of the input data; and an image for changing the group division standard. The input unit acquires the data for changing the group division standard as an input result. Moreover, the output unit outputs display data in which the classified data is divided into the plurality of groups based on the group division standard indicated by the input result.

### TECHNICAL FIELD

The present invention relates to a data classification device and the like.

### BACKGROUND ART

A lot of data is handled in business activities, and such data may be managed in different classification for each customer or for each department. In order to effectively utilize the data, it is desirable to reclassify the data managed in different classification, based on criteria according to applications such as marketing, sales, and product development. However, manually reclassifying the data produces enormous workload. Therefore, a system that supports data classification may be used. In such a system that supports data classification, for example, data is classified using a classification model that is a learning model generated by machine learning. In the classification of data using a classification model, it is desirable that it is possible to confirm the certainty of whether the classification is accurately performed. PTL 1 discloses a technique for confirming the certainty of data classification in such a system that supports data classification, for example.

PTL 1 describes an accounting system that acquires transaction information and classifies the transaction information into account titles corresponding to the contents of the transactions. The accounting system of PTL 1 outputs account titles estimated using a classification model generated by machine learning together with the reliability of classification.

### CITATION LIST

### Patent Literature

PTL 1: WO 2018/189825 A1

### SUMMARY OF INVENTION

### Technical Problem

However, the technique of PTL 1 is not sufficient in the following aspect. The accounting system of PTL 1 outputs the reliability of each classification result, but cannot confirm the tendency of reliability of the entire classified data. Therefore, the technique of PTL 1 is not sufficient as a technique for classifying data while recognizing the certainty of estimation of classification by a classification model.

In order to solve the above problem, an object of the present invention is to provide a data classification device and the like capable of easily confirming the certainty of estimation of classification of data by a classification model.

### Solution to Problem

In order to solve the above problem, a data classification device of the present invention includes: an acquisition means for acquiring data to be classified as input data; a data classification means for estimating classification of input data using a classification model for estimating the classification of the input data; an output means for outputting display data for displaying an image for displaying the classified data divided into a plurality of groups set according to a range of degree of confidence based on the degree of confidence indicating a certainty of estimation of the classification when the classification model estimates the classification of the input data and an image for changing a grouping criterion; and an input means for acquiring data of an input operation for changing the grouping criterion as an input result, in which the output means generates display data for displaying the classified data divided into the plurality of groups based on the grouping criterion indicated by the input result.

A data classification method according to the present invention includes: acquiring data to be classified as input data; estimating classification of the input data using a classification model for estimating the classification of the input data; outputting display data for displaying an image for displaying the classified data divided into a plurality of groups set according to a range of the degree of confidence and an image for changing a grouping criterion based on the degree of confidence indicating a certainty of estimation of the classification when the classification model estimates the classification of the input data; acquiring data of an input operation for changing the grouping criterion as an input result; and generating display data for displaying the classified data divided into the plurality of groups based on the grouping criterion indicated by the input result.

A program recording medium of the present invention records a data classification program for causing a computer to execute: acquiring data to be classified as input data; estimating classification of the input data using a classification model for estimating the classification of the input data; outputting display data for displaying an image for displaying the classified data divided into a plurality of groups set according to a range of a degree of confidence, based on degree of confidence indicating a certainty of estimation of the classification when the classification model estimates the classification of the input data, and an image for changing a grouping criterion; acquiring data of an input operation for changing the grouping criterion as an input result; and generating display data for displaying the classified data divided into the plurality of groups based on the grouping criterion indicated by the input result.

### Advantageous Effects of Invention

According to the present invention, it is possible to easily confirm the certainty of estimation of classification of data by a classification model.

### BRIEF DESCRIPTION OF DRAWINGS

FIG. 1 is a diagram illustrating an outline of a configuration of a first example embodiment of the present invention.

FIG. 2 is a diagram illustrating an example of a configuration of a data classification device according to the first example embodiment of the present invention.

FIG. 3 is a diagram illustrating an example of definition data of classification according to the first example embodiment of the present invention.

FIG. 4 is a diagram illustrating an example of training data according to the first example embodiment of the present invention.

FIG. 5 is a diagram illustrating an example of data to be classified according to the first example embodiment of the present invention.

FIG. 6 is a diagram illustrating an example of estimation results of classification according to the first example embodiment of the present invention.

FIG. 7 is a diagram illustrating an example of an operation flow of the data classification device according to the first example embodiment of the present invention.

FIG. 8 is a diagram illustrating an example of an operation flow of the data classification device according to the first example embodiment of the present invention.

FIG. 9 is a diagram illustrating an example of a display screen in a learning phase according to the first example embodiment of the present invention.

FIG. 10 is a diagram illustrating an example of a display screen in a learning phase according to the first example embodiment of the present invention.

FIG. 11 is a diagram illustrating an example of a display screen in a learning phase according to the first example embodiment of the present invention.

FIG. 12 is a diagram illustrating an example of a display screen in a learning phase according to the first example embodiment of the present invention.

FIG. 13 is a diagram illustrating an example of a display screen in an estimation phase according to the first example embodiment of the present invention.

FIG. 14 is a diagram illustrating an example of a configuration of a data classification device according to a second example embodiment of the present invention.

FIG. 15 is a diagram illustrating an example of an operation flow of the data classification device according to the second example embodiment of the present invention.

FIG. 16 is a diagram illustrating another configuration example of the embodiment of the present invention.

### EXAMPLE EMBODIMENT

### First Example Embodiment

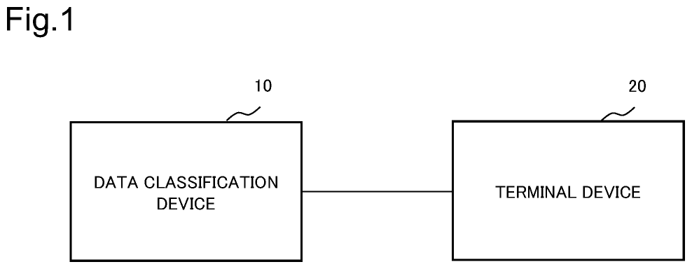

A first example embodiment of the present invention will be described in detail with reference to the drawings. FIG. 1 is a diagram illustrating an outline of a data classification system according to the present example embodiment. The data classification system of the present example embodiment includes a data classification device 10 and a terminal device 20. The data classification device 10 and the terminal device 20 are connected via a network. The data classification system of the present example embodiment is a system that estimates classification of input data using a classification model that is a learning model having undergone machine learning. The data classification system of the present example embodiment reclassifies classified data into a predefined classification scheme using a classification model.

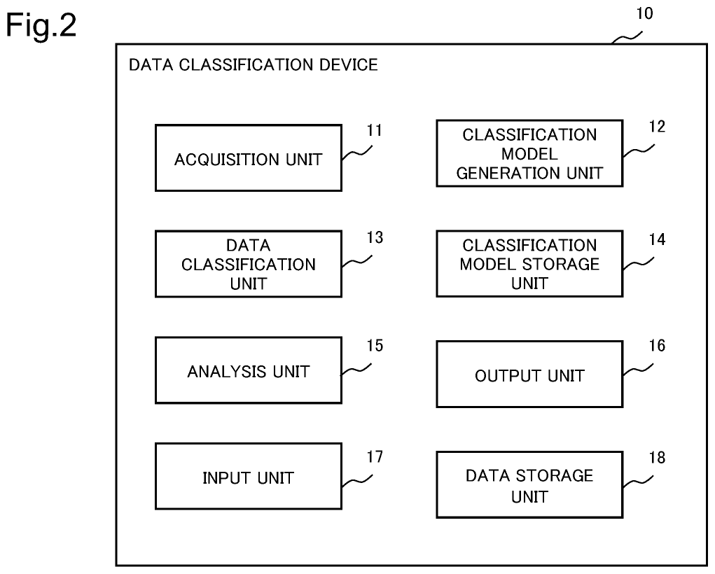

A configuration of the data classification device 10 will be described. FIG. 2 is a diagram illustrating an example of a configuration of the data classification device 10. The data classification device 10 includes an acquisition unit 11, a classification model generation unit 12, a data classification unit 13, a classification model storage unit 14, an analysis unit 15, an output unit 16, an input unit 17, and a data storage unit 18.

The acquisition unit 11 acquires definition data to be used in estimating the classification of data using a classification model. The definition data is data that defines levels of classification categories. The acquisition unit 11 acquires definition data input to the terminal device 20 by the worker from the terminal device 20, for example.

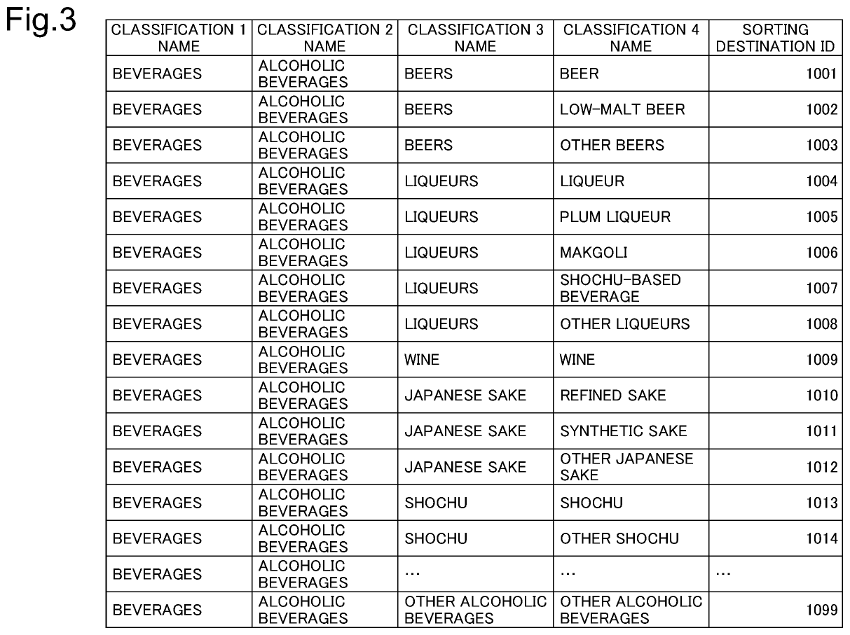

FIG. 3 is a diagram illustrating an example of definition data of levels of classification categories. FIG. 3 illustrates an example in which classification is set in four levels. In the example of FIG. 3, classification 1 indicates the top (the most abstract or highest-level) classification, and classification 2, classification 3, and classification 4 are more detailed in this order. The sorting destination ID (identifier) is a classification category, that is, an identification number of classification 4 which is the most detailed classification. The number of levels of the classification set in the definition data may be other than four.

The acquisition unit 11 acquires input data and labels used by the classification model generation unit 12 to generate a classification model. The input data is data in which the names of products and the classification of the products are associated with each other. The products may include services.

The labels are correct answer data of classification for the estimation of classification using a classification model. The labels indicate the most detailed classification among the product classifications. The labels may be set by identification numbers corresponding to the most detailed classification among the product classifications. The labels are also referred to as teacher data. A set of input data and label is also referred to as training data.

The acquisition unit 11 acquires input data and labels input to the terminal device 20 by the worker from the terminal device 20, for example. The acquisition unit 11 also acquires data to be classified by using a classification model from the terminal device 20. Data to be classified by using a classification model is input to the terminal device by the worker, for example. The acquisition unit 11 may acquire data to be classified by using a classification model from a device other than the terminal device 20. For example, the acquisition unit 11 may acquire data to be classified from a data management server connected via a network.

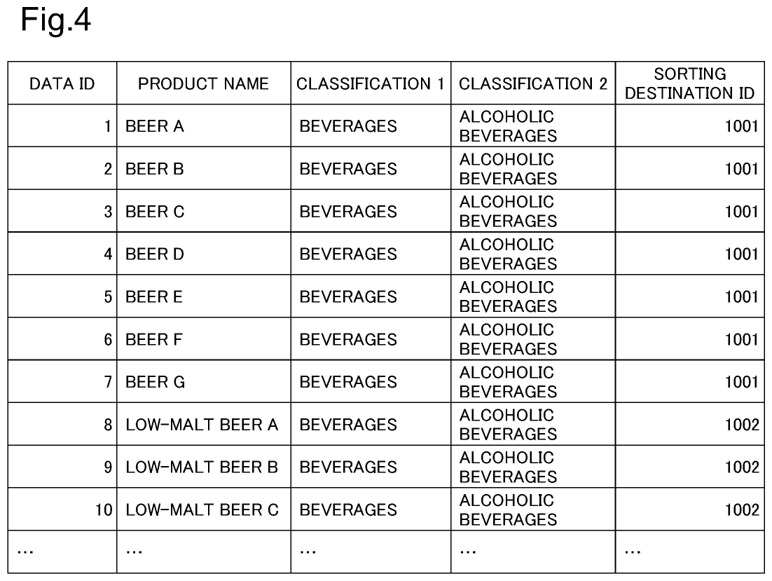

FIG. 4 is a diagram illustrating an example of training data. The training data illustrated in FIG. 4 includes a data IDs that are identifiers assigned to data, product names, classification 1 indicating large classification among two levels of classification, classification 2 indicating small classification among the two levels of classification, and sorting destination IDs indicating labels. The products are classified into any of the small classification. The classification hierarchy may be set in a plurality of levels other than two levels. The classification may be in one level. Data having different numbers of levels of classification hierarchy may be used as the input data.

The classification model generation unit 12 generates a classification model using the training data. Specifically, the classification model generation unit 12 executes machine learning using the names of the products and the classification of the products as input data and the correct answer data indicating the classification in the classification scheme of reclassification using the classification model as a label, and generates a trained model for estimating the classification of the products as a classification model. The classification model generation unit 12 performs machine learning using a neural network to generate a classification model, for example. The machine learning may be executed by a method using a network other than the neural network.

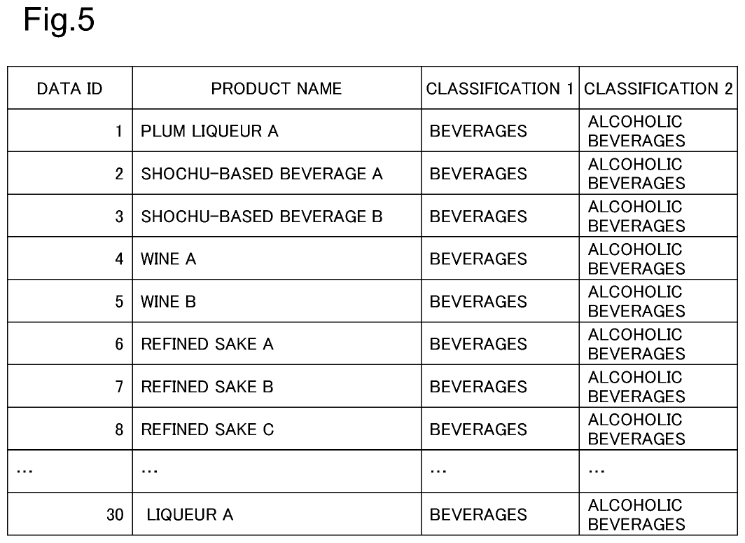

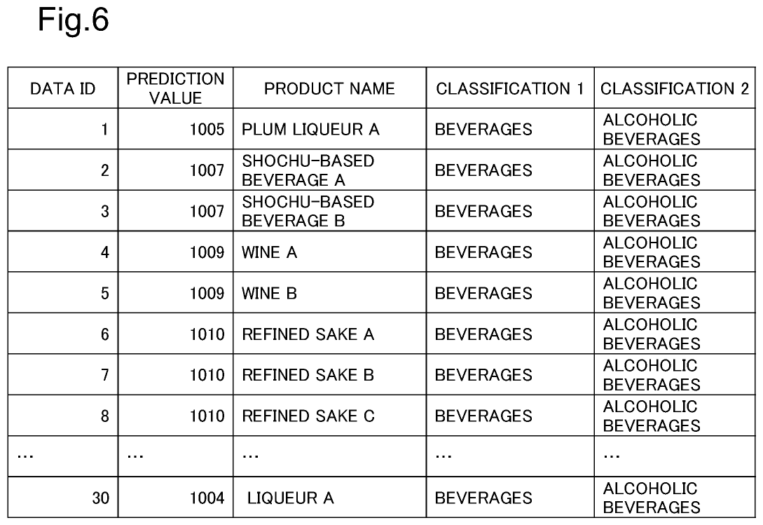

The data classification unit 13 uses the names of the products and the classification of the products as input data, and estimates the classification of the products in the classification scheme based on the definition data using the classification model. FIG. 5 is a diagram illustrating an example of input data. The input data in FIG. 5 includes data IDs which are identifiers of data, product names, classification 1 indicating large classification among two levels of classification, and classification 2 indicating small classification among the two levels of classification. FIG. 6 illustrates an example of results of classification by the classification model. In the results of classification in FIG. 6, classification estimation results are associated as prediction values with data similar to that in FIG. 5. The prediction values in FIG. 6 correspond to the sorting destination IDs in FIG. 3.

The classification model storage unit 14 stores data of the classification model generated by the classification model generation unit 12.

The analysis unit 15 compares the labels with the results of estimation of classification by the data classification unit 13 according to the generated classification model using test data among the training data as the input data, and calculates the estimation accuracy using the classification model. The test data is data that has not been used for generation of the classification model among the training data.

The analysis unit 15 calculates the degree of confidence in the classification results. The degree of confidence is an index that indicates the certainty of estimation of classification by the classification model. The degree of confidence indicates the reliability of the estimation results of classification by the classification model, and is also referred to as the degree of reliability. For example, the analysis unit 15 calculates a probability indicating the correctness (accuracy) of the results of classification by the classification model using the softmax function, and calculates the degree of confidence based on the probability indicating the correctness of the classification results. The degree of confidence is represented by a numerical value from 0 to 1 based on the probability indicating the correctness of the classification results, for example.

The output unit 16 generates display data of results of classification by the classification model. The output unit 16 generates display data for displaying the classification results divided into a plurality of groups based on the degree of confidence. The output unit 16 generates display data of a screen for performing an operation of changing a threshold of each group in grouping the classification results based on the degree of confidence. An example of the display data will be described later.

The output unit 16 outputs the generated display data to the terminal device 20. The output unit 16 may output the display data to a display device connected to the data classification device 10.

The input unit 17 acquires input data input to the terminal device by the worker's operation. The input unit 17 may acquire input data from an input device connected to the data classification device 10.

The data storage unit 18 stores training data and classification result data.

Each processing in the acquisition unit 11, the classification model generation unit 12, the data classification unit 13, the analysis unit 15, the output unit 16, and the input unit 17 is performed by executing computer programs on a central processing unit (CPU) (not illustrated), for example. The classification model storage unit 14 and the data storage unit 18 are configured using nonvolatile semiconductor storage devices, for example. The classification model storage unit 14 and the data storage unit 18 may be configured by other storage devices such as hard disk drives, or may be configured by a combination of a plurality of types of storage devices.

Each processing in the data classification device 10 may be performed in a manner of being distributed to a plurality of information processing apparatuses connected via a network. The classification model storage unit 14 and the data storage unit 18 may be formed on a storage device connected to the data classification device 10 via a network. The classification model storage unit 14 and the data storage unit 18 may be formed on a storage device included in an information processing apparatus connected to the data classification device 10 via a network.

The terminal device 20 displays the display data of the classification results acquired from the data classification device 10 on a display device (not illustrated). The terminal device 20 also transmits data input by the worker's operation according to the display data of the classification results to the data classification device 10 as input results. The terminal device 20 may be used for inputting input data when classification is performed using training data and a classification model. The terminal device 20 sends the input result data, the training data, and the input data to the data classification device 10.

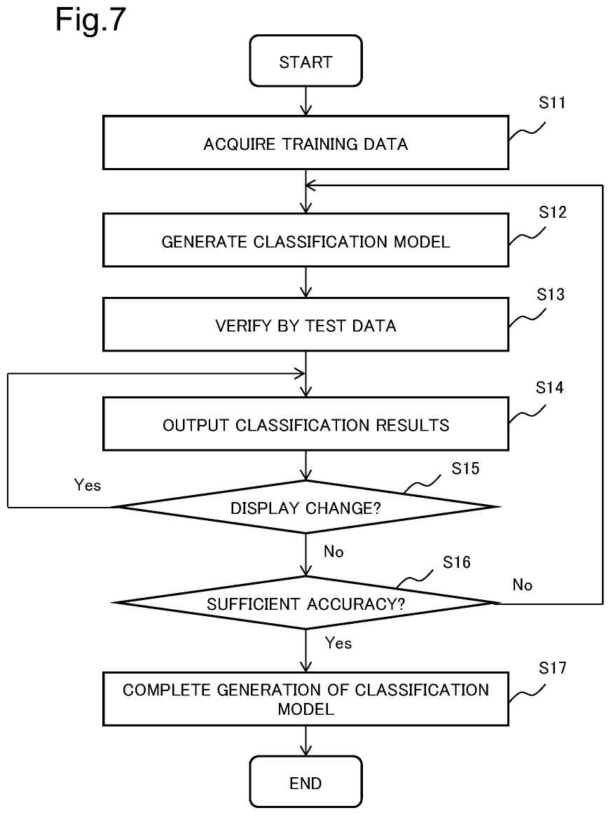

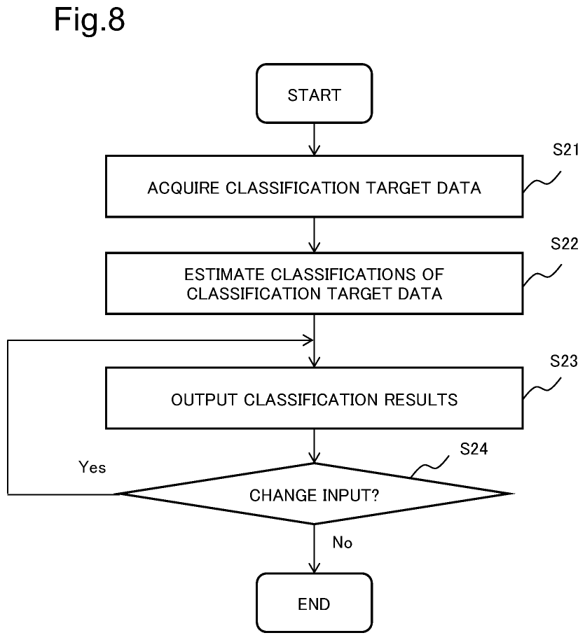

Operations of the data classification system of the present example embodiment will be described. FIGS. 7 and 8 are diagrams illustrating examples of flows of operations of the data classification device 10. Generation of a classification model will be described. In FIG. 7, the acquisition unit 11 of the data classification device 10 acquires training data for generating a classification model (for example, FIG. 4) (step S11). For example, the acquisition unit 11 acquires, from the terminal device 20, the training data input to the terminal device 20 by the worker's operation.

Upon acquisition of the training data, the classification model generation unit 12 performs machine learning using the names of products and the classification of the products as input data and the correct answer data of the classification in the classification scheme according to the purpose of classification by the classification model as labels, and generates a learning model as a classification model (step S12). The classification model generation unit 12 generates a classification model by machine learning using a neural network, for example.

Upon generating the classification model, the classification model generation unit 12 stores the generated classification model in the classification model storage unit 14. The classification model generation unit 12 repeats the generation of a classification model a preset number of times, for example.

Upon generating the classification model, the data classification unit 13 verifies the classification model using test data (step S13). The data classification unit 13 uses, as test data, data that has been not used to generate the classification model among the training data. The data classification unit 13 estimates classification by the classification model using the test data as input data. When the classification is performed by the classification model, the analysis unit 15 collates the classification results with the labels associated with the input data, and calculates the correct-answer rate. The analysis unit 15 specifies a match between a classification result and a label as a correct answer and calculates the correct-answer rate.

Upon calculating the correct-answer rate of the results of classification by the classification model, the output unit 16 generates display data of the classification results. Upon generating the display data of the classification results, the output unit 16 outputs the display data of the classification results to the terminal device 20 (step S14). Upon receiving the display data, the terminal device 20 displays the classification results on a display device (not illustrated).

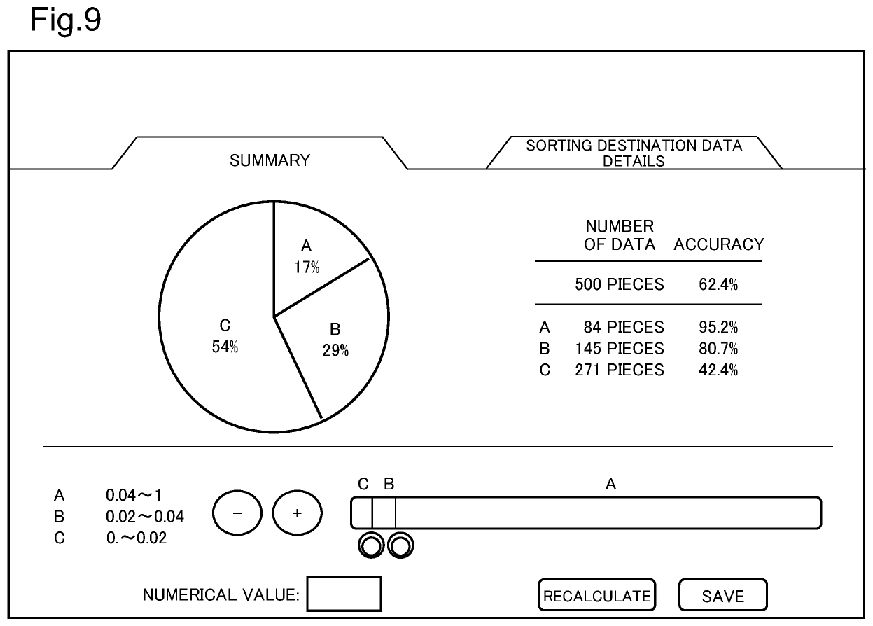

FIG. 9 illustrates an example of a display screen of classification results displayed on the terminal device 20 when classification is estimated using test data as input data. The display screen of FIG. 9 illustrates an example in which two tabs of summary and sorting destination data details are set, and the tab of the summary indicating the outline of the classification results is selected. FIG. 9 also illustrates an example in which the classification results are divided into three stage groups according to the degree of confidence.

Numerical values on the lower left of FIG. 9 indicate thresholds in a plurality of divided stages of the degree of confidence. The numerical values on the lower left of FIG. 9 indicate that A is a group in which the degree of confidence is 0.04 to 1, B is a group in which the degree of confidence is 0.02 or more and less than 0.04 that is lower than the group A, and C is a group in which the degree of confidence is less than 0.02 that is lower than the group B.

The circular graph in FIG. 9 indicates the ratio of the number of data among groups into which the classification results are sorted according to the degree of confidence. The circular graph in FIG. 9 indicates that the ratio of the data of the degree of confidence belonging to group A is 17%, the ratio of the data of the degree of confidence belonging to group B is 29%, and the ratio of the data of the degree of confidence belonging to group C is 54% among the total number of test data classified by the classification model.

The numerical values on the right side of the circular graph in FIG. 9 indicate the numbers of data of the degree of confidence in the groups A, B, and C and the number of total data, and the average values of the accuracy of the data in the groups A, B, and C and the average value of the accuracy of the total data. The accuracy of the data is calculated as a value indicating in percentage a correct-answer rate that is a rate at which the results of classification by the classification model and the labels match. Specifically, the numerical values on the right side of the circular graph in FIG. 9 indicate that the average value of the accuracy of 500 pieces of data is 62.4%, the average value of the accuracy of 84 pieces of data in the group A is 95.2%, the average value of the accuracy of 145 pieces of data in the group B is 80.7%, and the average value of the accuracy of 271 pieces of data in the group C is 42.4%.

The horizontal bar displayed as a band graph at the lower right of FIG. 9 indicates a range of thresholds (range between 0 and 1) for distinguishing each stage of the degree of confidence. In FIG. 9, for example, sliding a circle button below the band graph leftward or rightward makes it possible to change a threshold for distinguishing each stage of the degree of confidence.

When the worker who has viewed the classification results illustrated in FIG. 9 inputs data for requesting a change in display, the terminal device 20 transmits the input result of data to the data classification device 10.

The input unit 17 of the data classification device 10 acquires the input result from the terminal device 20. When the input unit 17 acquires the input result indicating a display change (Yes in step S15), the output unit 16 generates display data according to the input result. Upon generating the display data of the classification results, the output unit 16 outputs the display data of the classification results to the terminal device 20.

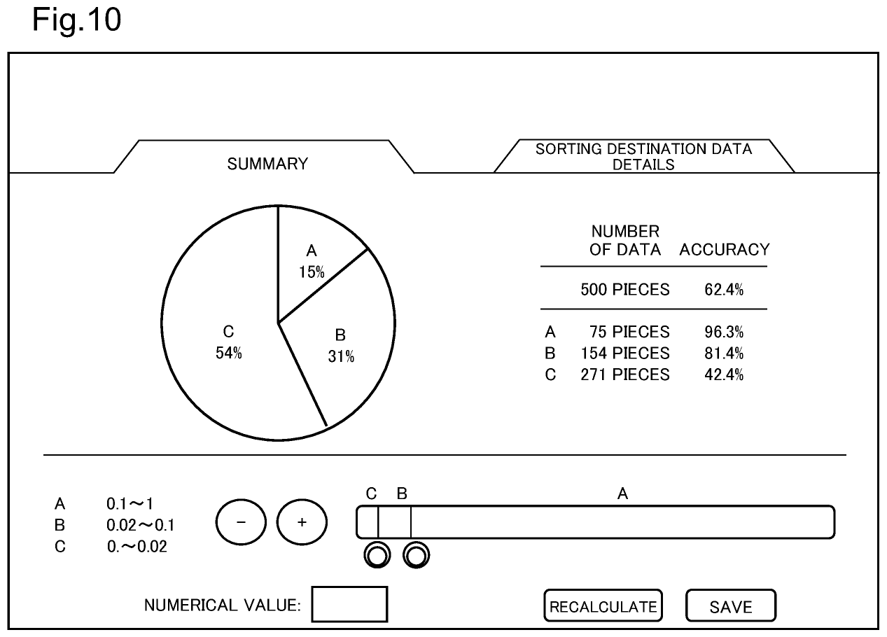

FIG. 10 illustrates an example of a display screen displayed on the terminal device 20 when the display is changed from the display screen in FIG. 9. In FIG. 10, the threshold of the degree of confidence for distinguishing the groups A and B is changed to 0.1. For example, the worker slides the button below the band graph rightward to change the threshold to a larger value. In addition. The worker may change the threshold by designating the position to be changed and inputting the threshold in the numerical value field. In FIG. 10, since the range of A is narrowed and the range of B is widened, the number of data in the group A is decreased to 75 and the number of data in the group B is increased to 154. In this way, by changing the range of the degree of confidence, the worker can easily confirm the ratio of the number of data for each degree of confidence after the change.

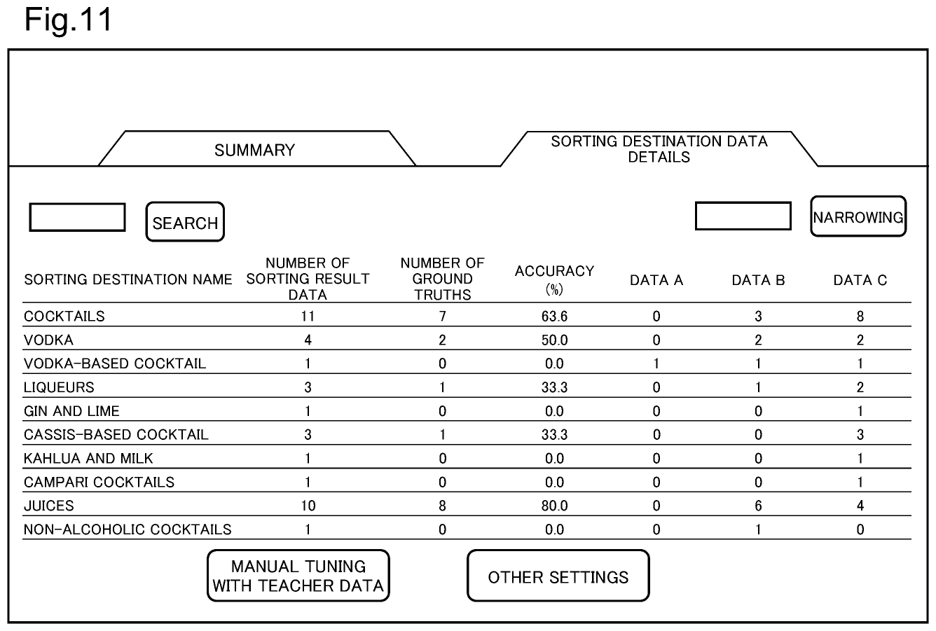

FIG. 11 illustrates an example of a display screen displayed on the terminal device 20 when the sorting destination data details tab is selected. In FIG. 11, the classification estimated using the classification model is displayed as the names of sorting destinations. The sorting destination name is the name of the most detailed classification. In addition, the number of sorting result data indicating the number of data corresponding to each classification, the number of ground truth, the average value of accuracy, the number of data in the group A, the number of data in the group B, and the number of data in the group C are displayed in a list. The items displayed in the list may include items other than the above items. Providing a display screen on which display can be changed by a tab in this manner makes it possible to easily check details of data and an overall trend. In addition, the list data as illustrated in FIG. 11 may be displayed on the display screen in FIG. 9 by the click of the mouse or by a touch on the touch panel at the position in each group on the circular graph.

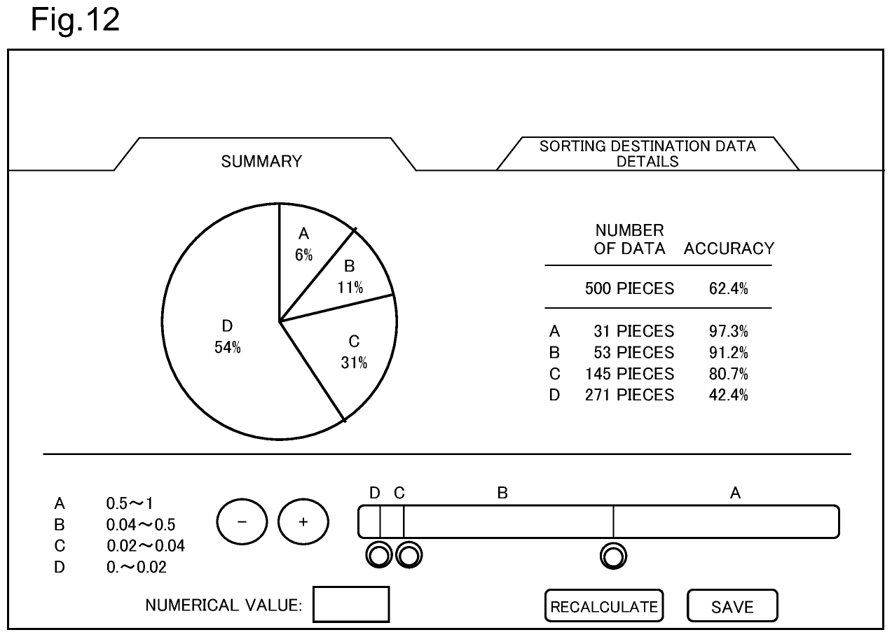

FIG. 12 illustrates an example of a display screen displayed on the terminal device 20 when the number of groups based on the degree of confidence is changed. In FIG. 12, the classification results are divided into four groups according to the degree of confidence. The threshold for grouping is set by selecting a round button displayed under a boundary between groups in the band graph and inputting a numerical value in a numerical value input field, for example. The threshold may be changed by selecting and sliding a boundary line portion. The number of groups is increased when the “+” button on the left of the band graph is pressed, for example. The number of groups is decreased when the “−” button is pressed.

If the display is not changed in the input result (No in step S15) and the accuracy of the estimation by the classification model is sufficient (Yes in step S16), the data classification device 10 completes the process of generating the classification model (step S17). Whether the accuracy of the estimation by the classification model is sufficient is input via the terminal device 20 by the worker's selection operation, for example.

A criterion of determining the accuracy of the estimation for completing generation of the classification model may be set in advance. The reference of determining the accuracy of the estimation for completing the generation of the classification model may be set based on the accuracy of the degree of confidence in a predetermined group. In such a case, the criterion of determining the accuracy of the estimation for completing the generation of the classification model is set such that the accuracy of the group A in FIG. 9 is 95% or more, for example.

If the display is not changed (No in step S15) In the input result and the accuracy of the estimation by the classification model is not sufficient (No in step S16), the data classification device 10 performs an operation of generating a classification model in the classification model generation unit 12 in step S12.

Next, operations for estimating the classification of data using a classification model will be described. Referring to FIG. 8, the acquisition unit 11 of the data classification device 10 acquires data to be subjected to classification estimation as input data (step S21). For example, the acquisition unit 11 acquires, from the terminal device 20, data to be reclassified using a classification model input to the terminal device 20 by the worker's operation.

Upon acquiring the input data, the data classification unit 13 estimates the classification of the input data using the classification model stored in the classification model storage unit 14 (step S22).

When the classification of the input data are estimated, the analysis unit 15 calculates the degree of confidence for each classification result. When the degrees of confidence are calculated, the output unit 16 generates display data of the classification results. Upon generating the display data of the classification results, the output unit 16 outputs the display data of the classification results to the terminal device 20 (step S23). Upon receiving the display data, the terminal device 20 displays the classification results on a display device (not illustrated).

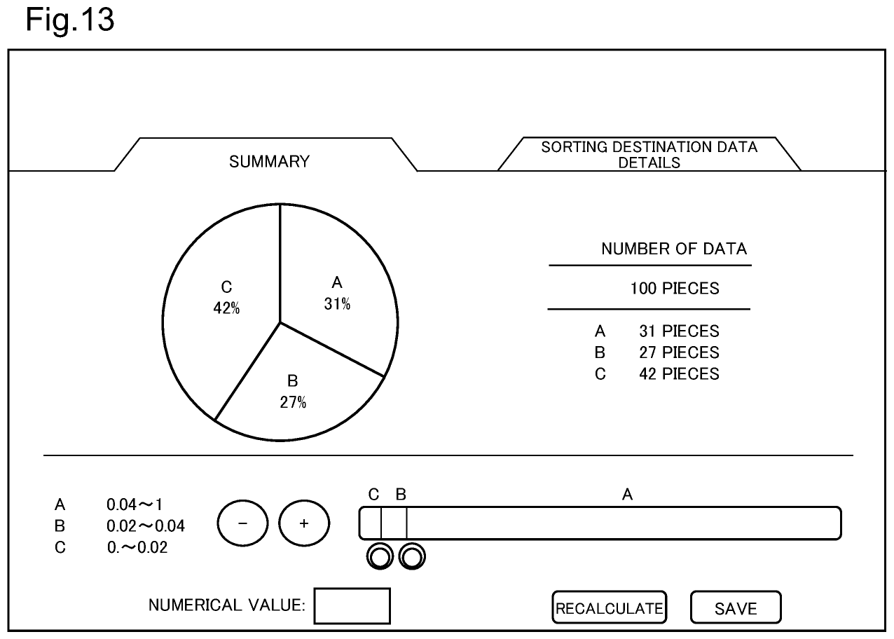

FIG. 13 illustrates an example of a display screen of classification results of classification estimation using the classification model. FIG. 13 illustrates an example in which the classification results are divided into three stage groups according to the degree of confidence. Numerical values on the lower left of FIG. 13 indicate thresholds in a plurality of divided stages of the degree of confidence. The numerical values on the lower left of FIG. 13 indicate that A is a group in which the degree of confidence is 0.04 to 1, B is a group in which the degree of confidence is 0.02 or more and less than 0.04, and C is a group in which the degree of confidence is less than 0.02.

The circular graph in FIG. 13 indicates the ratio of the numbers of data at the individual stages. The circular graph in FIG. 13 indicates that the ratio of the data of the degree of confidence of group A is 31%, the ratio of the data of the degree of confidence of group B is 27%, and the ratio of the data of group C is 42% among the total number of the classification target data classified by the classification model.

On the display screens as illustrated in FIGS. 9, 10, and 12, the circular graph and the band graph may be color-coded for each group of the degree of confidence. In the case of color-coding and displaying each group of the degree of confidence, the visibility of the display screen can be improved by unifying the colors of the same group in the circular graph and the band graph.

When the worker who has viewed the classification results inputs data for requesting a change in display, the terminal device 20 transmits the input data as the input result to the data classification device 10.

The input unit 17 of the data classification device 10 acquires the input result from the terminal device 20. When the input unit 17 acquires the input result indicating a display change (Yes in step S24), the output unit 16 generates display data according to the input result. Upon generating the display data of the classification results, the output unit 16 outputs the display data of the classification results to the terminal device 20. If there is no change in display in the input result (No in step S24), the data classification device 10 ends the operation of data classification.

In the above description, the data classification device 10 generates only one classification model, but may generate different classification models for individual classification schemes defined according to the purpose. For example, in the case of reclassifying data by different classification schemes in the sales department, the marketing department, and the development department, the data classification device 10 generates classification models for the individual purposes using training data to which labels based on classification schemes according to the purposes are added. Adopting a configuration in which a classification model according to a purpose is selected for reclassification of data, it is possible to enhance convenience of classification results while further improving accuracy of classification estimation. A plurality of classification models may be generated for the same purpose. For example, after classification is performed using a plurality of classification models generated for the same purpose, classification results to be adopted may be selected with reference to the degree of confidence.

In the example described above, products are classified. However, the data classification system of the present example embodiment can also be applied to classification of matters other than products. For example, in a company, personnel data can be reclassified according to the purpose of use by generating a classification model according to the purpose of use of the personnel data. In addition, in a hospital, a school, a government office, or another organization, data can be reclassified according to the purpose of use by generating a classification model according to the purpose of use of data.

The data classification device 10 of the data classification system of the present example embodiment generates a classification model for reclassifying classified data into classification set according to a purpose by machine learning. The data classification device 10 can estimate the classification of the data using the classification model to reclassify the data of a classification scheme not corresponding to the use purpose based on the classification scheme according to the use purpose.

When generating the classification model and estimating the classification using the classification model, the data classification device of the present example embodiment calculates the degrees of confidence of the classification results and outputs display data obtained by grouping the classification results into groups set in a plurality of stages based on the degrees of confidence. By grouping the classification results based on the degrees of confidence, the data classification device 10 can present the classification results in the groups according to the certainty of estimation of the classification.

The data classification device 10 of the present example embodiment changes the threshold for each group in grouping the classification results in response to the changing operation, and outputs the display data of the classification results grouped based on the changed threshold. The data classification device 10 also outputs the display data in which the number of groups is changed in response to the operation of changing the number of groups in grouping the classification results. Since the data classification device 10 produces a display in which the grouping threshold and the number of groups are changed in response to the operations in this manner, it is possible to more easily verify the certainty of classification in classifying data using the classification model. As a result, using the data classification system of the present example embodiment makes it possible to easily confirm the certainty of the estimation of the classification of the data by the classification model.

### Second Example Embodiment

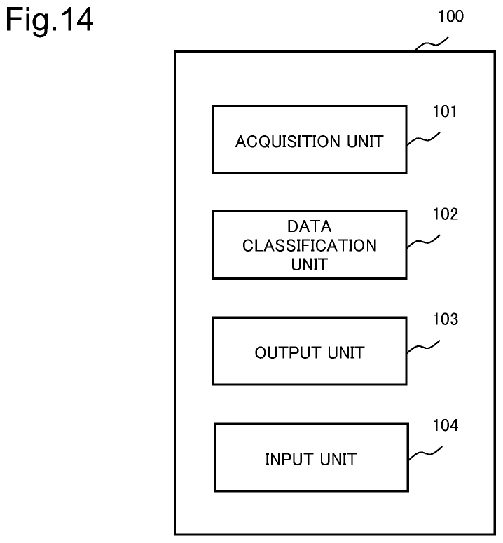

A second example embodiment of the present invention will be described in detail with reference to the drawings. FIG. 14 is a diagram illustrating an example of a configuration of a data classification device 100 according to the present example embodiment. The data classification device 100 of the present embodiment includes an acquisition unit 101, a data classification unit 102, an output unit 103, and an input unit 104.

The acquisition unit 101 acquires data to be classified as input data. The data classification unit 102 estimates the classification of the input data using a classification model for estimating the classification of the input data. The output unit 103 outputs display data for displaying an image for displaying the classified data divided into a plurality of groups set according to the range of the degrees of confidence and displayed in each group, and an image for changing a grouping criterion, based on the degree of confidence indicating the certainty of the estimation of the classification when the classification model estimates the classification of the input data. The input unit 104 acquires the data of an input operation for changing the grouping criterion as an input result. Moreover, the output unit 103 generates display data for displaying the classified data divided into the plurality of groups based on the grouping criterion indicated by the input result.

The acquisition unit 11 of the first example embodiment is an example of the acquisition unit 101. The acquisition unit 101 is an aspect of an acquisition means. The data classification unit 13 and the classification model storage unit 14 of the first example embodiment are examples of the data classification unit 102. The data classification unit 102 is an aspect of a data classification means. The output unit 16 and the data storage unit 18 of the first example embodiment are examples of the output unit 103. The output unit 103 is an aspect of an output means. The input unit 17 of the first example embodiment is an example of the input unit 104. The input unit 104 is an aspect of an input means.

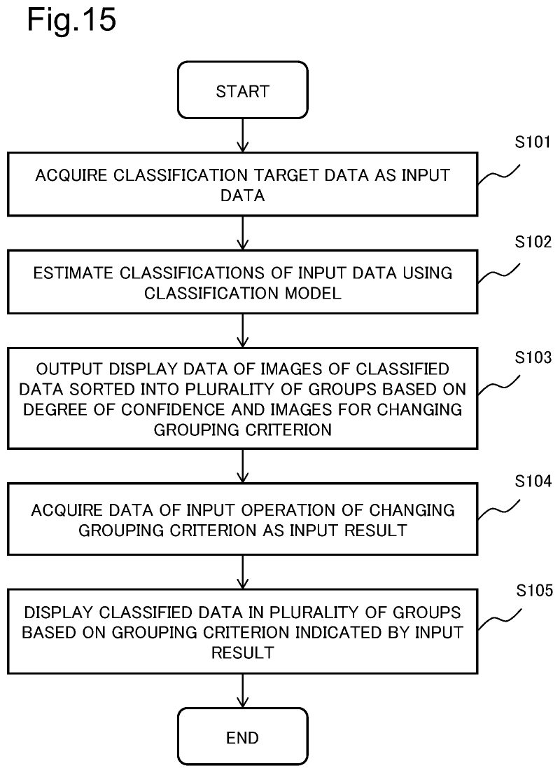

An operation of the data classification device 100 will be described. FIG. 15 is a diagram illustrating an example of an operation flow of the data classification device 100 according to the present example embodiment.

The acquisition unit 101 acquires data to be classified as input data (step S101). When the input data is acquired, the data classification unit 102 estimates the classification of the input data using a classification model for estimating the classification of the input data (step S102). When the classification of the input data is estimated, the output unit 103 outputs display data for displaying an image for displaying the classified data divided into a plurality of groups set according to the range of the degrees of confidence and displayed in each group, and an image for changing a grouping criterion, based on the degree of confidence indicating the certainty of the estimation of the classification when the classification model estimates the classification of the input data (step S103). The input unit 104 acquires the data of an input operation for changing the grouping criterion as an input result (step S104). When the input result is acquired, the output unit 103 generates display data for displaying the classified data divided into the plurality of groups based on the grouping criterion indicated by the input result (step S105).

The data classification device 100 of the present example embodiment outputs display data of a screen for displaying classification results divided into a plurality of groups and a screen for changing the grouping criterion. The data classification device 100 also acquires data of an input operation for changing the grouping criterion as an input result, and outputs display data for displaying the classified data divided into a plurality of groups based on the acquired grouping criterion. Therefore, using the data classification device 10 of the present example embodiment makes it possible to change the grouping criterion of the certainty of the classification results while watching the display data after changing the criterion. As a result, using the data classification device of the present example embodiment makes it possible to easily confirm the certainty of the estimation of the classification of the data by the classification model.

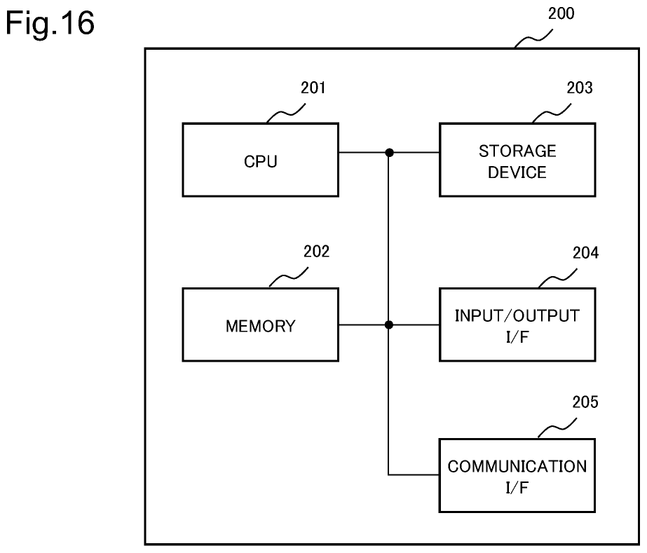

Each processing in the data classification device 10 of the first example embodiment and the data classification device 100 of the second example embodiment can be performed by executing a computer program on a computer. FIG. 16 illustrates an example of a configuration of a computer 200 that executes a computer program for performing each processing in the data classification device 10 of the first example embodiment and the data classification device 100 of the second example embodiment. The computer 200 includes a CPU 201, a memory 202, a storage device 203, an input/output interface (I/F) 204, and a communication I/F 205.

The CPU 201 reads and executes a computer program for performing each processing from the storage device 203. The CPU 201 may include a combination of a CPU and a graphics processing unit (GPU). The memory 202 includes a dynamic random access memory (DRAM) or the like, and temporarily stores a computer program executed by the CPU 201 and data being processed. The storage device 203 stores a computer program executed by the CPU 201. The storage device 203 includes a nonvolatile semiconductor storage device, for example. As the storage device 203, another storage device such as a hard disk drive may be used. The input/output I/F 204 is an interface that receives an input from the worker and outputs display data and the like. The communication I/F 205 is an interface that transmits and receives data to and from each device constituting the data classification system. The terminal device 20 can have a similar configuration.

The computer program used for executing each processing can also be stored and distributed in the form of a recording medium. The recording medium may be a magnetic tape for data recording or a magnetic disk such as a hard disk, for example. The recording medium may also be an optical disk such as a compact disc read only memory (CD-ROM). The recording medium may be a non-volatile semiconductor storage device.

The present invention has been described above by taking the above-described example embodiments as examples. However, the present invention is not limited to the above-described example embodiments. That is, the present invention is applicable to various aspects that can be understood by those skilled in the art within the scope of the present invention.

This application is based upon and claims the benefit of priority from Japanese patent application No. 2021-11603, filed on Jan. 28, 2021, the disclosure of which is incorporated herein in its entirety by reference.

### REFERENCE SIGNS LIST

10 Data classification device
11 Acquisition unit
12 Classification model generation unit
13 Data classification unit
14 Classification model storage unit
15 Analysis unit
16 Output unit
17 Input unit
18 Data storage unit
20 Terminal device
100 Data classification device
101 Acquisition unit
102 Data classification unit
103 Output unit
104 Input unit
200 Computer
201 CPU
202 Memory
203 Storage device
204 Input/output I/F
205 Communication I/F

What is claimed is:

1. A data classification device comprising:
at least one memory storing instructions; and
at least one processor configured to access the at least one memory and execute the instructions to:
acquire data to be classified as input data;
estimate a classification of input data using a classification model for estimating a classification of the input data;
output first display data for displaying an image for displaying the classified data divided into a plurality of groups set according to a range of degree of confidence based on the degree of confidence indicating a certainty of estimation of the classification when the classification model estimates the classification of the input data, and an image for changing a grouping criterion;
acquire data of an input operation for changing the grouping criterion as an input result; and
output second display data for displaying the classified data divided into the plurality of groups based on the grouping criterion indicated by the input result.

2. The data classification device according to claim 1, wherein
the at least one processor is further configured to execute the instructions to:
output the first display data for displaying a band graph of a range of the grouping criterion and at least one of an input field of a numerical value of the grouping criterion or a button for changing the grouping, criterion; and
output the second display data for displaying the classified data divided into the plurality of groups, based on the input result indicating an input of the numerical value to the input field acquired by the input means or an operation of the button.

3. The data classification device according to claim 2, wherein
the at least one processor is further configured to execute the instructions to:
output the first display data for displaying a button for operating a change in number of the plurality of groups together with the band graph; and
output the second display data for displaying the classified data, by changing the number of the plurality of groups, based on the input result indicating an operation of the button.

4. The data classification device according to claim 1, wherein
the at least one processor is further configured to execute the instructions to:
generate a classification model by machine learning using names of classification targets, input data including classification data of a plurality of levels for each of the classification targets, and labels indicating classification of the classification targets.

5. The data classification device according to claim 4, wherein
the at least one processor is further configured to execute the instructions to:
estimate the classification of the input data to which the label is added using the classification model;
calculate a correct-answer rate of the estimated classification as accuracy; and
output the first display data for displaying the accuracy for each of the groups.

6. The data classification device according to claim 1, wherein
the at least one processor is further configured to execute the instructions to:
output the first display data for displaying a screen for performing an operation for switching to a list display of the classification targets included in the groups.

7. A data classification method comprising:
acquiring data to be classified as input data;
estimating classification of the input data using a classification model for estimating the classification of the input data;
outputting first display data for displaying an image for displaying the classified data divided into a plurality of groups set according to a range of the degree of confidence and an image for changing a grouping criterion based on the degree of confidence indicating a certainty of estimation of the classification when the classification model estimates the classification of the input data;
acquiring data of an input operation for changing the grouping criterion as an input result; and
outputting second display data for displaying the classified data divided into a plurality of groups based on the grouping criterion indicated by the input result.

8. The data classification method according to claim 7, comprising:
outputting the first display data for displaying a band graph of a range of the grouping criterion and at least one of an input field of a numerical value of the grouping criterion or a button for changing the grouping criterion, and
outputting the second display data for displaying the classified data divided into the plurality of groups, based on the input result indicating an input of the numerical value to the input field or an operation of the button.

9. The data classification method according to claim 8, comprising:
outputting the first display data for displaying a button for changing number of the plurality of groups together with the band graph; and
outputting the second display data for displaying the classified data, by changing the number of the plurality of groups, based on the input result indicating an operation of the button.

10. A non-transitory program recording medium recording a data classification program for causing a computer to execute:
acquiring data to be classified as input data;
estimating classification of the input data using a classification model for estimating the classification of the input data;
outputting first display data for displaying an image for displaying the classified data divided into a plurality of groups set according to a range of a degree of confidence, based on the degree of confidence indicating a certainty of estimation of the classification when the classification model estimates the classification of the input data, and an image for changing a grouping criterion;
acquiring data of an input operation for changing the grouping criterion as an input result; and
outputting second display data for displaying the classified data divided into the plurality of groups based on the grouping criterion indicated by the input result.
